(19) United States
(12) Patent Application Publication
(10) Pub. No.: US 2009/0279969 A1
(43) Pub. Date: Nov. 12, 2009

(54) A FIXATION DEVICE FOR FIXATING A PORTABLE DRILLING MACHINE TO A DRILL TEMPLATE

(75) Inventor: Stefan Mejerwall, Upplands Vasby (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: NOVATOR AB, Spanga (SE)

(21) Appl. No.: 12/438,776

(22) PCT Filed: Aug. 29, 2007
(86) PCT No.: PCT/SE07/50590

§ 371 Date: May 8, 2009

(51) Int. Cl. B23B 47/28

(52) U.S. Cl. 408/115 R

(57) ABSTRACT

A fixation device for fixating a portable drilling machine to a drill template, comprising a housing having a distal end holding a clamping mechanism configured to detachably fixate the housing onto two locating pins attached to and projecting from a drill template diametrically opposed to each of a plurality of guide holes therein. The clamping mechanism includes a support member having two diametrically opposed recesses for receiving the respective locating pins therein. Axial end surface portions of the support member are configured to engage an opposing surface of the template when the fixation device is attached to the locating pins. A sleeve-shaped piston is rotatable and axially movable in a cylinder within the support member. A distal end of the piston has two helical cams with wedge surfaces configured to come into engagement with a respective undercut cam surface of each locating pin upon rotating and axially displacing the piston.

### BACKGROUND OF THE INVENTION

1. Field of the Invention

The present invention relates to a fixation device for fixating a portable drilling machine, in particular a portable orbital drilling machine, to a drill template.

2. Description of the Related Art

WO 02/102535 discloses a fixation device wherein two locating pins are attached to and project from the template proximate and diametrically opposed to each hole therein, and the fixation device comprises a clamping mechanism mounted to a housing for coupling a housing template end with each of said two locating pins. The clamping mechanism includes a piston located within the housing, a clamping actuator, an unclamping actuator, and two ball holders attached to distal end of the housing. Each ball holder is configured to concentrically circumscribe a respective one of the two locating pins. The twin ball holder arrangement of the clamping is rather complex and expensive, and the stability of the fixation of the drilling machine to the template is in some instances, in particular when performing so called orbital drilling where great radial forces are exerted, not sufficient for high precision demands.

WO 94/17944, WO 01/15870 and U.S. Pat. No. 5,088,171 disclose further examples of devices for fixating a drilling machine to a drill template wherein two locating pins are attached to and project from the template proximate and diametrically opposed to each hole therein. Even here the stability of the fixation of the drilling machine to the template is sometimes insufficient due to large tolerances of locking surfaces of only two locating pins.

PCT/SE2006/000083 discloses a fixation device for fixating a portable orbital drilling machine to a drill template and comprises a housing assembly configured to be detachably secured to the drilling machine; distal locking members projecting from a housing body of said assembly and configured to receive corresponding locating pins fixated to the template at a distance from a template hole, said locking members having a respective pin-receiving opening configured to receive a head and a stud of a respective locating pin. In order to improve the properties as to the ability of taking up radial forces generated during an orbital hole-making process and obtain better stability when fixated to the locating pins on the template, the fastening device comprises three locking members, each having a respective pin-receiving key-hole opening for receiving a respective one of three locating pins which are disposed at a respective apex of an imaginary equilateral triangle relative to a template hole. This gives a more stable fixation of the drilling machine to the template, but the size and the complexity of the fixation device increases.

### SUMMARY OF THE INVENTION

An object of the present invention is to provide a fixation device of the kind mentioned above having a simplified structure and which has improved properties as to the ability of taking up radial forces generated during an orbital hole-making process and a better stability when fixated to two locating pins attached to and projecting from the template proximate and diametrically opposed to each hole therein.

For this purpose the fixation device of the invention includes a housing having a proximal end configured to be detachably secured to a drilling machine, and a distal end having a clamping mechanism configured to detachably fixate the housing onto two locating pins securely attached to and projecting from a drill template proximate and diametrically opposed to each of a plurality of guide holes therein. The clamping mechanism includes a support member projecting from the distal end of the housing and having two diametrically opposed recesses for receiving the respective locating pins therein. The support member has axial end surface portions configured to engage an outer, opposing surface of the template when the fixation device is attached to the locating pins. The clamping mechanism further includes a sleeve-shaped piston which is rotatable and axially movable in a cylinder in the housing and extending coaxially with and inside the support member. The distal end of the piston has two helical cams with wedge surfaces facing towards the housing and configured to come into engagement with a respective undercut cam surface of each locating pin. The cams are chamfered at diametrically opposed positions on the piston to allow for an insertion of the helical cams underneath the undercut cam surface of the locating pin when, after having attached the fixation device onto the locating pins on the template, rotating the piston in the cylinder. When connecting an inlet port in the housing to a source of a pressurized medium (pneumatic or hydraulic source) the piston is caused to perform an axial movement thereby creating a camming or wedge action between the helical cams of the piston and the undercut surfaces of the locating pins such that the axial end surfaces of the support member, and thus the fixation device and the drill attached thereto, are steadily pressed against the outer surface of the template.

In order to compensate for any existing tolerances of the distance between the undercut surfaces of the locating pins relative to the outer surface of the template, the piston may also perform a limited tilting movement in the cylinder such that both cams of the piston may be adjusted to exert the same fixation force on the locating pins. All these various movements of the piston relative to the cylinder may be performed by means of pneumatic, hydraulic, electric or manual assistance.

Further details and features of the fixation device of the present invention will be described in the following detailed description of a preferred embodiment thereof with reference to the accompanying drawings.

### BRIEF DESCRIPTION OF THE DRAWINGS

FIG. 1 is a perspective view of a portable drilling machine attached to two locating pins fixated on either side of a guide hole in a drill template;

FIG. 2 is a longitudinal cross-section through the fixation device of the present invention;

FIG. 3 is an exploded perspective view of the fixation device of the present invention;

FIG. 4 is a perspective view of a clamping piston of the fixation device of the present invention;

FIG. 5 is a perspective view from the distal end of the fixation device in a locating pin-receiving position of the clamping piston;

FIG. 6 is a perspective view similar to FIG. 6 of the fixation device in a locating pin-locking position of the clamping piston; and

FIG. 7 is a cross-sectional view of the nose portion of the fixation device and of the drill template with locating pins on either side of guide holes therein.

### DESCRIPTION OF A PREFERRED EMBODIMENT OF THE INVENTION

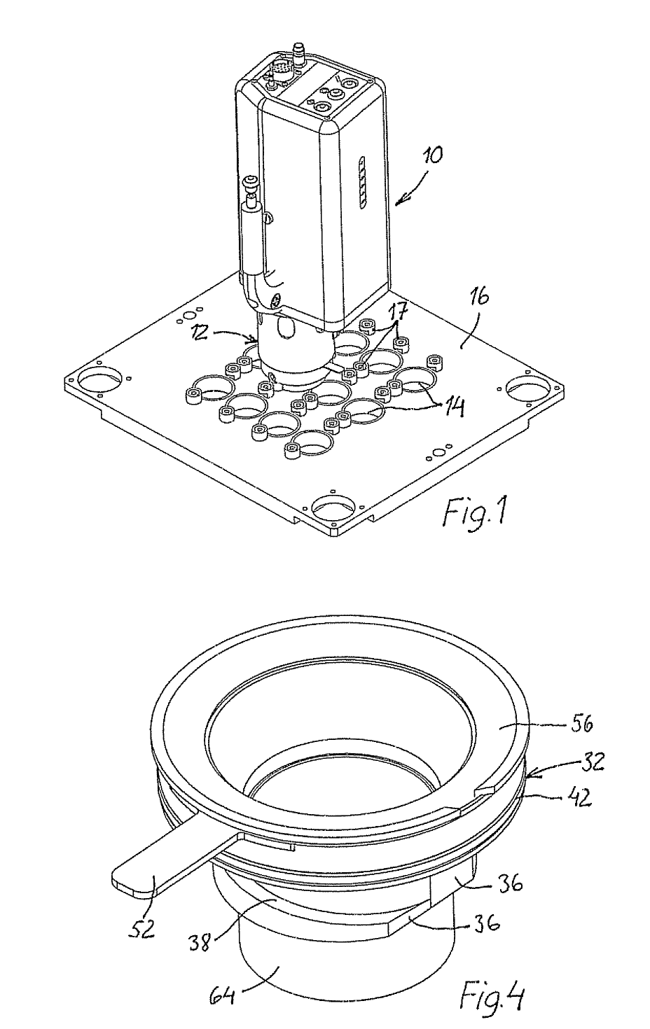

FIG. 1 illustrates a portable orbital drilling machine 10 having attached thereto a fixation device 12 of the present invention for detachably fixating the drilling machine 10 in one of a plurality of guide holes 14 in a drill template 16 by means of two diametrically disposed locating pins 17 associated with each hole 14. The template 16 is adapted to be fixated to a workpiece (not shown) in which a plurality of holes are to be produced at predetermined positions by means of the drilling machine 10.

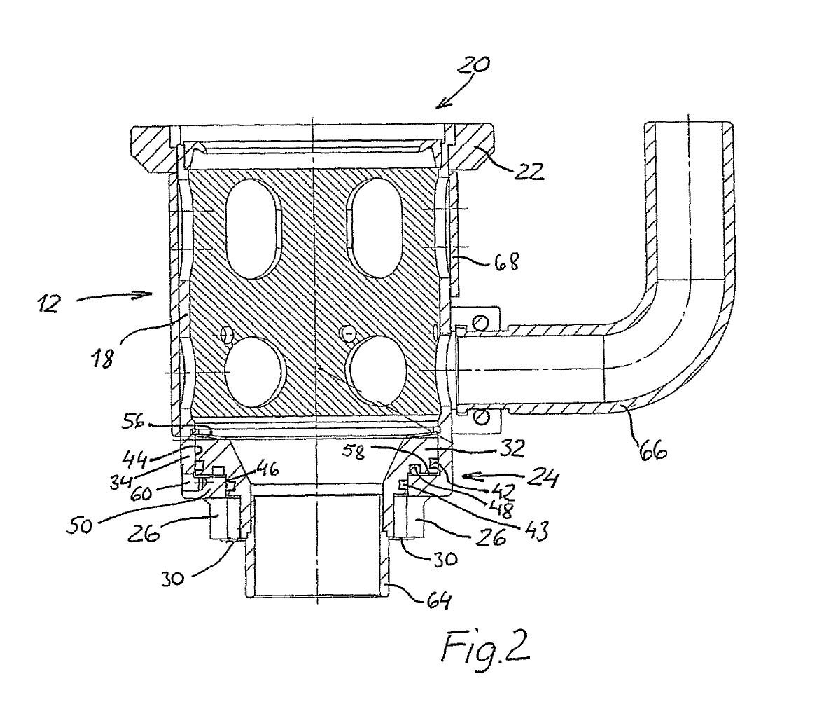

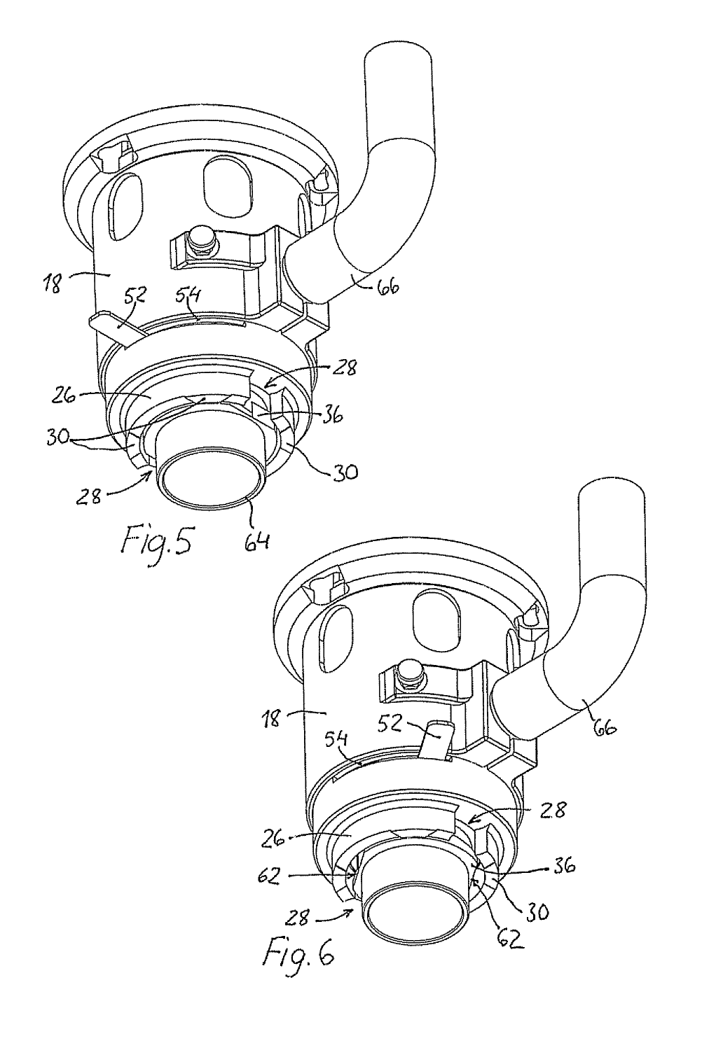

As shown in FIG. 2, the fixation device 12 comprises a sleeve-like housing 18 having a proximal end 20 configured to be detachably secured to the drilling machine by means of a clamping ring 22, and a distal end 24 having a clamping mechanism configured to detachably fixate the housing 18 to two locating pins 17 securely fastened to and projecting from the drill template 16 proximate and diametrically opposed to a respective guide hole 16 therein (FIGS. 1 and 7). The clamping mechanism comprises a support member 26 projecting from the distal end 24 of the housing 18 and having two diametrically opposed recesses 28 (see FIGS. 5 and 6) for receiving the respective locating pins 17 therein. The support member 26 has axial end surface portions 30 configured to engage the outer, opposing surface of the template 16 when the fixation device 12 is attached to the locating pins 17.

The clamping mechanism further includes a sleeve-shaped piston 32 which is rotatable and axially movable and somewhat tiltable in a cylinder 34 in the housing 18 and extending coaxially with and inside the support member 26. As shown in FIG. 4, the distal end of the piston 32 has two helical cams 36 with wedge surfaces 38 facing towards the housing 18 and configured to come into engagement with a respective undercut cam surface 40 of each locating pin 17 (see FIG. 7).

The piston 32 has two sealing rings 42, 43 for sealing the piston 32 against respective stepped cylinder walls 44 and 46. An axial bearing 48 (FIG. 2) is provided between the piston 32 and a shoulder 50 defining the cylinder wall 46 in order to facilitate rotation of the piston 32 relative to the cylinder 34. The rotation of the piston 32 may be performed manually by means of a lever 52 extending through a slot 54 in the housing 18 (see FIGS. 4-6). Optionally, the rotation may be performed by pneumatic or hydraulic drives (not shown). A Belleville washer 56 is biasing the piston 32 towards an outwardly projecting position. An interspace 58 between the piston 32 and the cylinder 34 communicates with an inlet port 60 for connecting the interspace 58 to a source of a pressurized medium (not shown), such as a pneumatic or hydraulic source. Thus, the piston 32 works as a single-acting piston in the cylinder 34.

As best shown in FIG. 6, the cams 36 are chamfered at diametrically opposed positions (at 62) on the piston 32 to allow for an insertion of the helical cams 36 underneath the undercut cam surface 40 of the locating pin 17, when, after having attached the fixation device 12 to the locating pins 17 on the template 16, rotating the piston 32 in the cylinder 34 with help of the lever 52. Then, the inlet port 60 is connected to the source of the pressurized medium so that the piston 32 is caused to perform a slight axial movement away from the shoulder 50, thereby creating a camming or wedging action between the helical cams 36 of the piston 32 and the undercut surfaces 40 of the locating pins 17 such that the axial end surfaces 30 of the support member 26, and thus the fixation device 12 and the drilling machine 10 attached thereto, are steadily pressed against the outer surface of the template 14.

Additionally, in order to compensate for any existing tolerances of the distance between the undercut surfaces 40 of the locating pins 17 relative to the outer surface of the template 16, the piston 32 may also perform a small, limited tilting movement in the cylinder 34, when connecting the pressurized source to the interspace 58, there-by causing the piston 32 to move towards a retracted position against the force of the Belleville washer 56 such that both cams 36 of the piston 32 may be adjusted to exert the same fixation force on the locating pins 17 over the wedge surfaces 38 and thus secure a stable fixation of the drilling machine 10 on the template 16.

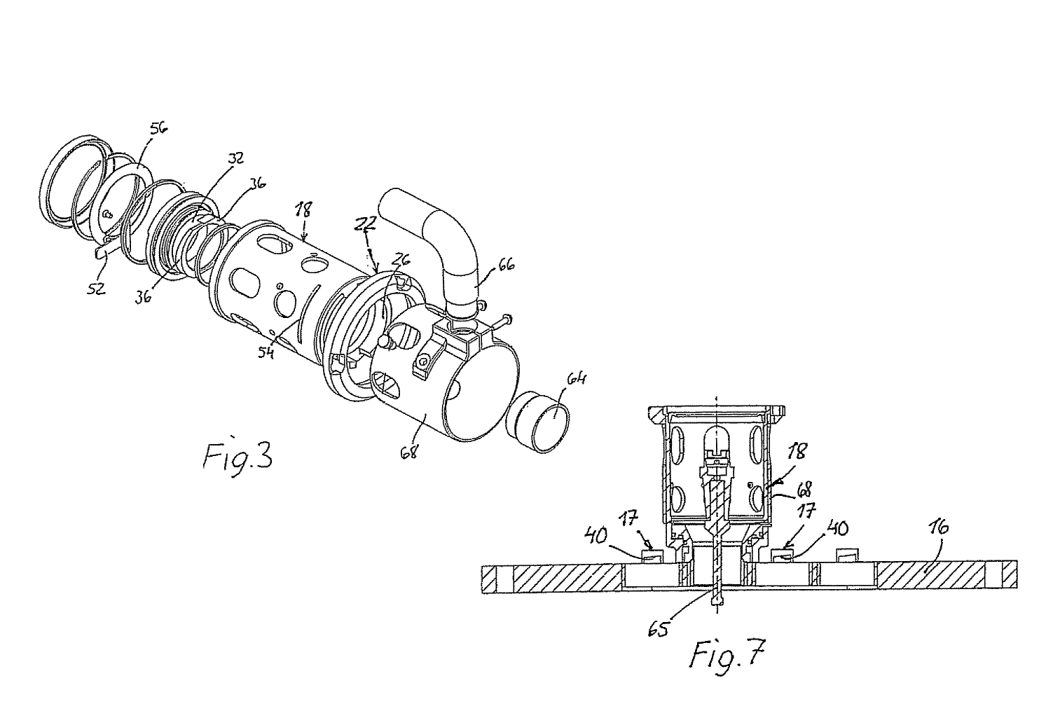

FIG. 5 illustrates a pin-receiving position of the piston 32, whereas FIG. 6 illustrates a pin-locking position thereof. As shown in FIGS. 2 and 3, an exchangeable guide sleeve 64 fitting in the guide holes 14 of the template 16 and protecting the cutting tool 65 (FIG. 7) may be inserted in the piston 32. A chips extracting tube 66 communicating with a vacuum source (not shown) is attached to an outer sleeve 68 which encompasses the housing 18.

1. A fixation device for fixating a portable drilling machine, in particular a portable orbital drilling machine, to a drill template, comprising a housing having a proximal end configured to be detachably secured to a drilling machine, and a distal end holding a clamping mechanism configured to detachably fixate the housing onto two locating pins securely attached to and projecting from a drill template proximate and diametrically opposed to each of a plurality of guide holes therein, wherein the clamping mechanism includes:
a support member projecting from the distal end of the housing and having two diametrically opposed recesses for receiving the respective locating pins therein, the support member having axial end surface portions configured to engage an outer, opposing surface of the template when the fixation device is attached to the locating pins; and
a sleeve-shaped piston which is rotatable and axially movable in a cylinder in the housing and extending coaxially with and inside the support member, a distal end of the piston having two helical cams with wedge surfaces facing towards the housing and configured to come into engagement with a respective undercut cam surface of each locating pin, said cams being chamfered at diametrically opposed positions on the piston to allow for an insertion of the helical cams underneath the undercut cam surface of the locating pin when, after having attached the fixation device onto the locating pins on the template, rotating the piston in the cylinder.

2. The fixation device according to claim 1, wherein the piston is axially movable by a pressure medium at least in a direction into the housing.

3. The fixation device according to claim 2, wherein a Belleville washer is biasing the piston towards an outwardly projecting position thereof.

4. The fixation device according to claim 1, wherein the piston is configured to perform a limited tilting movement in the cylinder.
